(19) United States
(12) Patent Application Publication
(10) Pub. No.: US 2017/0345345 A1
(43) Pub. Date: Nov. 30, 2017

(54) SIGN FOR STATUS INDICATION

(71) Applicant: June Jones, Fort Worth, TX (US)

(72) Inventor: June Jones, Fort Worth, TX (US)

(21) Appl. No.: 15/162,750

(22) Filed: May 24, 2016

(51) Int. Cl. G09F 7/18

(52) U.S. Cl. CPC G09F 7/18; G09F 2007/1852

(57) ABSTRACT

A sign assembly for indicating the status of dishes within a dishwasher that includes: a vertical rod; a two sided sign connected to the vertical rod; at least one magnet incorporated into the two sided sign; a first indicator designated on a first side of the sign; and a second indicator designated on a second side of the sign. The vertical rod includes a metal ball at a top end of the vertical rod and a metal ball at a bottom end of the vertical rod. The first indicator designates a clean status of dishes and the second indicator designates a dirty status of dishes.

### BACKGROUND OF THE INVENTION

### Field of Invention

The present invention relates to a sign that indicates the status of dishes within a dishwasher.

### Description of Related Art

Dishwashers are a common appliance that are used in most households. A dishwasher functions to wash dishes to alleviate the need for manual washing of dishes and utensils. Most dishwashers have a white or a metal surface and are closed during operation. For the most part, dishwashers function without any supervision by the user. A user places the dishwasher into a wash cycle and the dishwasher goes through the washing cycle. Many users step away from the dishwasher and go about other tasks or simply relax while the dishwasher does the work. However, many households have multiple individuals that may be utilizing the dishwasher. Therefore, it is advantageous to have a means to alert users of the status of the dishwasher through the use of an indicating system. Presently there are small magnet signs that may be used to indicate the status of the dishes within a dishwasher. However further innovation in this particular area could be helpful.

### SUMMARY OF THE INVENTION

The present invention relates to a sign assembly for indicating the status of dishes within a dishwasher that includes: a vertical rod; a two sided sign connected to the vertical rod; at least one magnet incorporated into the two sided sign; a first indicator designated on a first side of the sign; and a second indicator designated on a second side of the sign. The vertical rod includes a metal ball at a top end of the vertical rod and a metal ball at a bottom end of the vertical rod. The first indicator designates a clean status of dishes and the second indicator designates a dirty status of dishes.

### BRIEF DESCRIPTION OF DRAWINGS

FIG. 1 depicts a first indicator associated with a sign indicator in accordance with the present invention.

FIG. 2 depicts a second indicator associated with the sign indicator in accordance with the present invention.

### DETAILED DESCRIPTION

The present invention relates to a sign that is utilized to indicate the status of dishes within a dishwasher. This sign includes a vertical metal rod that supports the sign, which covers the outside surface of a conventional dishwasher. The sign includes magnets that are incorporated in the sign to attach to and connect to a surface of the dishwasher. The sign further includes a metal ball at the bottom end of the vertical rod. Further a decorative metal ball sign may be placed at the top end of the vertical rod. On the first side of the sign is a first indicator designating the status of dishes within a dishwasher. On the second side of the sign is a second indicator designating a second status of the dishes within a dishwasher. Dishes within a dishwasher typically have two states of existence. The dishes within the dishwasher may be clean therefore the dishes have gone through a wash cycle. Or alternatively the dishes may be dirty and therefore the wash cycle has not been initiated by a user.

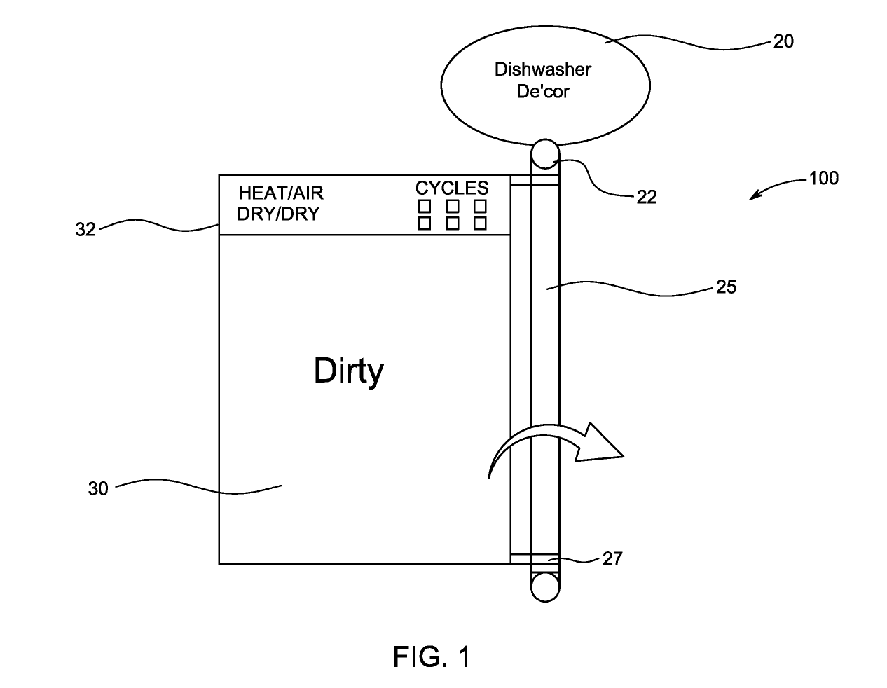

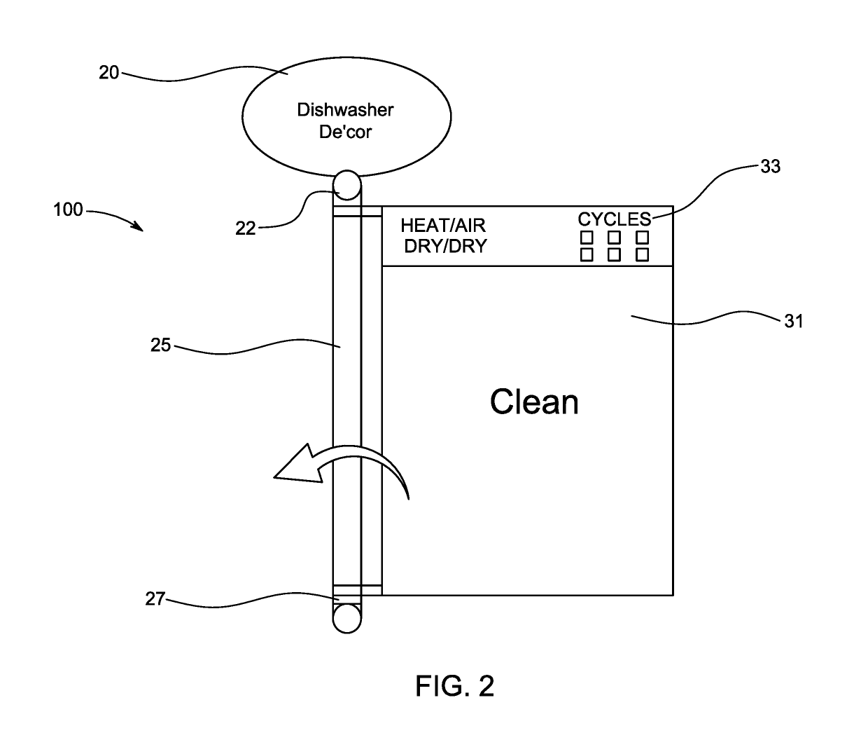

In reference to FIG. 1, a view of a sign assembly 100 in accordance with the present invention is depicted. The sign assembly 100 includes a vertical rod 25. Attached to the vertical rod is a two-sided sign 30, 31. The two-sided sign 30, 31 includes an indicator of dishwasher status written on each side, as shown in FIGS. 1 and 2. In FIG. 1, “Dirty” is written indicating dirty dishes are stored within the dishwasher, so the dishwasher has not gone through a wash cycle. Further above the text is a faux depiction of a dishwasher cycle. The vertical rod 25 may further include a metal round ball 27 at the bottom end of the vertical rod 25. Further a metal round ball 22 may be placed on top of the vertical rod 25 to affix a decorative sign 20 as shown in FIG. 1.

FIG. 2 depicts the opposite side of the sign 30, 31. The vertical rod 25 may be swiveled and then attached through magnets within the two-sided sign 30, 31 to the surface of a dishwasher. In FIG. 2, “Clean” is written indicating clean dishes are stored within the dishwasher, therefore the wash cycle has been completed for this particular load of dishes and utensils. Use of the current invention provides a convenient and effective means to provide a dishwasher status indicator for a consumer. The instant invention has been shown and described in what it considers to be the most practical and preferred embodiments. It is recognized, however, that departures may be made there from within the scope of the invention and that obvious modifications will occur to a person skilled in the art.

1. A sign assembly for indicating the status of dishes within a dishwasher comprising:
a vertical rod;
a two-sided sign connected to the vertical rod on one sided of the two-sided sign;
at least one magnet incorporated into the two-sided sign, where the at least one magnet affixes the two-sided sign to the dishwasher;
a first indicator designated on a first side of the sign, wherein the first indicator is visible when the vertical rod is placed on a first side of the dishwasher; and
a second indicator designated on a second side of the sign, wherein the second indicator is visible when the vertical rod is placed on a second side of the dishwasher.

2. The sign assembly for indicating the status of dishes according to claim 1, where the vertical rod includes a metal ball at a top end of the vertical rod.

3. The sign assembly for indicating the status of dishes according to claim 1, where the vertical rod includes a metal ball at a bottom end of the vertical rod.

4. The sign assembly for indicating the status of dishes according to claim 1, where the first indicator designates a clean status of dishes.

5. The sign assembly for indicating the status of dishes according to claim 1, where the second indicator designates a dirty status of dishes.
